(19) United States
(12) Patent Application Publication
(10) Pub. No.: US 2002/0138476 A1
(43) Pub. Date: Sep. 26, 2002

(54) Document managing apparatus

(75) Inventors: Misako Suwa, Kawasaki (JP); Satoshi Naoi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/961,319

(22) Filed: Sep. 25, 2001

(30) Foreign Application Priority Data
Mar. 22, 2001 (JP) 2001-082189

(51) Int. Cl. G06F 7/00

(52) U.S. Cl. 707/3

(57) ABSTRACT

A paper document printed from an electronic document, in which a note is taken, is input as an image from a paper document inputting unit such as a scanner, an electronic camera, etc. A note image is extracted by a note extracting unit. The note image is then recognized by a note recognizing unit. A note recognition result and the note image are correlated to the original electronic document, and stored. Data of the correlation between the note data and the original electronic document is stored in a document information file.

### BACKGROUND OF THE INVENTION

1. Field of the Invention

The present invention relates to a document managing apparatus correlating and managing an original electronic document generated by a word processor, etc., a file obtained by extracting a note that a person takes in a distributed paper document which is printed from the electronic document and by recognizing the extracted note, and an image file of the note.

2. Description of the Related Art

With the recent popularization of personal computers, a document that is conventionally printed on paper and used has been generated by a tool such as a word processor, etc., and the original data of the document has been managed as an electronic document.

If an electronic document generated by a word processor, etc. is printed on paper and distributed at a meeting, etc., participants in the meeting take notes in the margin of the document in many cases. An existing document managing apparatus can manage an electronic document, but cannot handle a note. However, a note that a participant in a meeting takes in the margin, etc. of a paper document includes important information, etc. of a discussion made at the meeting. Therefore, the paper document cannot be discarded. Eventually, the original electronic document and the paper document in which the note is taken are doubly managed, which leads to troublesomeness.

As described above, a document printed on paper is distributed to persons who actually reference the document, and matters expected to be important are usually taken as notes in the paper document. Therefore, it is impossible to make fully electronic management of information.

### SUMMARY OF THE INVENTION

An object of the present invention is to provide a document managing apparatus simultaneously managing a note taken in a distributed paper document that is printed from an electronic document generated by a word processor, etc., and the original electronic document.

A document managing apparatus according to the present invention is a document managing apparatus that electronically manages a note taken in a paper document printed from an electronic document. This apparatus comprises a reading unit reading as an image a document in which a note is taken, an extracting unit extracting information about the note from the read image, and a unit correlating and electronically storing the electronic document and the information about the note.

Conventionally, information of a note taken in a paper document that is printed from an electronic document is stored by holding the paper document. However, according to the present invention, a note is electronically managed as information about a note, such as raw image data, its recognition result, etc. This eliminates the need for storing a paper document, so that information can be efficiently managed. Especially, an electronic document and information about a note are correlated and stored, whereby a user can obtain the information about a note by easily displaying the note correlated to the electronic document at any time.

### BRIEF DESCRIPTION OF THE DRAWINGS

FIG. 1 is a schematic diagram explaining the configuration and the operations of a document managing apparatus according to a preferred embodiment of the present invention;

FIG. 2 is a flowchart showing a note extraction/recognition process;

FIG. 3 explains the concept of a note region extraction process;

FIG. 4 is a flowchart showing a note information registration/correlation process;

FIG. 5 explains the format of a file stored in a document information file;

FIG. 6 is a flowchart showing a document search process;

FIG. 7 exemplifies a display of a document list in the case where note data exists;

FIG. 8 exemplifies a display of an original electronic document, a note recognition result, and a note image;

FIG. 9 explains the hardware configuration of an information processing device that is required when the apparatus according to the preferred embodiment is implemented by causing the information processing device to execute a program; and

FIG. 10 explains a use pattern of a program (data)

### DESCRIPTION OF THE PREFERRED EMBODIMENTS

A document managing apparatus according to a preferred embodiment of the present invention comprises: a function registering an electronic document; a paper document inputting function capturing as image data the electronic document distributed as a paper document in which a note is taken, by using a scanner, an electronic camera, etc.; a note extracting function extracting only the note from the image in which the note is taken; a note managing unit recognizing the extracted note image portion, and putting the recognized note image into a file along with the corresponding image; and a file managing unit correlating and managing the original electronic document, the note file, and the note image. This apparatus can electronically manage a note and an electronic document at the same time, which leads to a reduction in troublesomeness of doubly managing paper and electronic documents, and to ease of reuse of data and information.

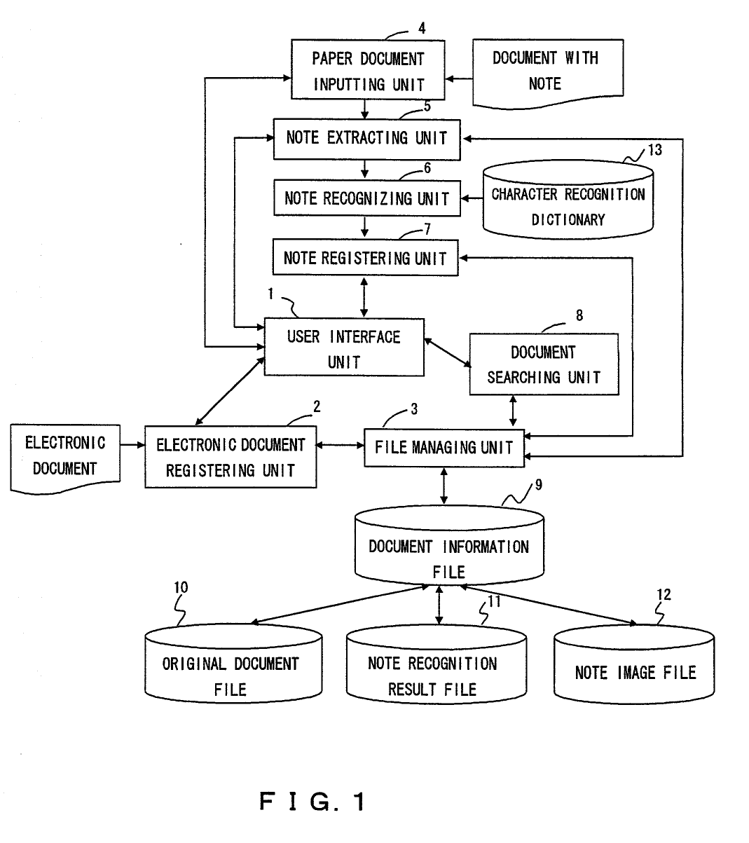

FIG. 1 is a schematic diagram explaining the configuration and the operations of a document managing apparatus according to a preferred embodiment of the present invention.

A user interface unit 1 is configured by a keyboard, a mouse, a display, etc., and allows a user interaction process. An electronic document registering unit 2 registers an electronic document upon receipt of a user request from the user interface unit 1, and generates a document information file for holding information of each document, such as a pointer in a memory, a document name, an author name, a creation time, the number of pages, etc. The document information file will be described later.

A paper document inputting unit 4 is configured by a scanner, etc., and captures a paper document as an image when a user issues a process request via the user interface unit 1. A note extracting unit 5 extracts a note image from the paper document image based on original electronic document data that a user specifies via the user interface unit 1. A specific note extraction process will be described later. A note recognizing unit 6 performs character recognition for the extracted note image while referencing a character recognition dictionary 13. Since recognized characters can possibly include an error, a recognition result can be also corrected at this time. The correction is made with an existing technique.

To a note registering unit 7, a note recognition result file is registered. A file managing unit 3 correlates file information such as a note recognition file, a note image file, etc. to an original electronic document automatically or with a user specification, and writes the correlated information to a document information file. If the file information is correlated to the original electronic document automatically, electronic documents are searched based on the information of a character string or a ruled line of a paper document image, so that a corresponding electronic document is found. For a search using a ruled line or a character string, by way of example, the technique disclosed by the invention of the pending application filed by the present applicant, or the technique disclosed by Japanese Patent Publication No. 10-240958 is used.

When a user issues a document search request via the user interface unit 1, a document searching unit 8 interprets the user request, and requests the file managing unit 3 to search for a document. The file managing unit 3 accesses a document information file 9, and searches for a corresponding file. If the user issues a word search request in all documents via the user interface unit 1, the file managing unit 3 accesses a file within the document information file 9, an original document file 10, and a note recognition result file 11 to make a word search. Furthermore, an original electronic document, a note recognition result, a note image, etc. are displayed according to a user request. In this case, the note image is read from a note image file 12 based on the information of the document information file 9.

Besides, a function for calculating attribute information such as the location, the size, etc. of a note, and searching for an electronized paper document by using the attribute information of a note may be arranged as a function for managing a note in a paper document. Furthermore, the file managing unit 3 has a function for managing and displaying an original electronic document, an electronized paper document, and information of presence of a note, which are correlated to one another, and also has a function for obtaining a desired document from the above described documents depending on need.

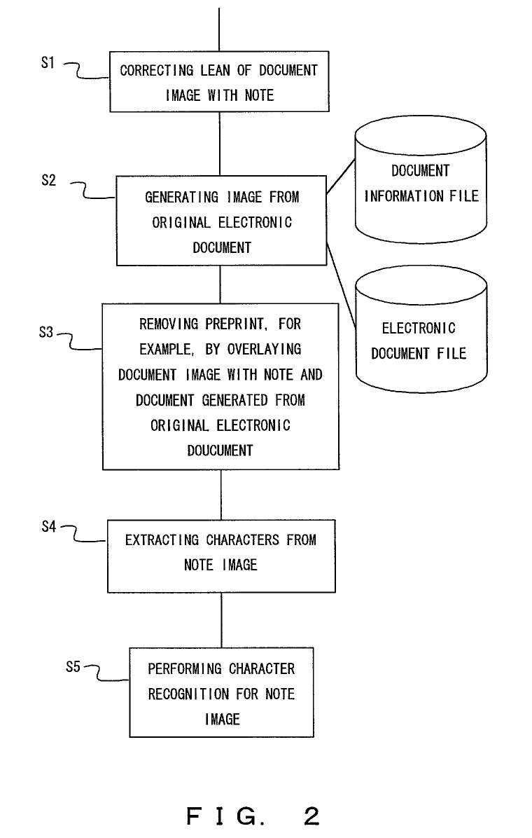

FIG. 2 is a flowchart showing a note extraction/recognition process.

The note extracting unit corrects a lean of a document image with a note, which a user inputs with a scanner, and corrects the image to be upright if the image has a lean. Furthermore, the note extracting unit makes a comparison between the document image with the note and a corresponding original electronic image, and removes a preprint (characters which are included in an electronic document, etc., and printed on paper) portion from the document image with the note. Specifically, a document image is generated from the original electronic document so that the generated image and the document image with the note become equal in size, and the preprint portion is removed with an existing technique such as overlaying the generated image on the document image with the note. The remaining portion is then extracted with the techniques written by the following documents, etc.

N. Babaguchi, M. Tsukamoto, and H. Aihara, “Fundamental Consideration of Character Extraction from a Handwritten Japanese Character String”, IEICE Transactions Vol. J68-D, No. 12 2123-2131, December '85

S. Fujii and K. Omori, “Handwritten Character String Recognition System Using a Character Extraction Process Based on a Contact Pattern of Characters—Development of a Character Code String Generator”, Meeting on Image Recognition and Understanding (MIRU '94), July 1994, I-123-i-130

The note recognizing unit performs character recognition for a note image which is obtained by character extraction by using a character recognition dictionary.

The flow of the process is explained with reference to FIG. 2.

Firstly, in step S1, a lean of a document image with a note is corrected. In step S2, an image is generated from an original electronic image. At this time, an electronic document to be read is identified by referencing a document information file, and the identified electronic document is read from an electronic document file. Then, in step S3, a preprint is removed, for example, by overlaying the document image with the note and the document generated from the original electronic document. In step S4, characters are extracted from the image with the note. In step S5, character recognition is performed for the image with the note.

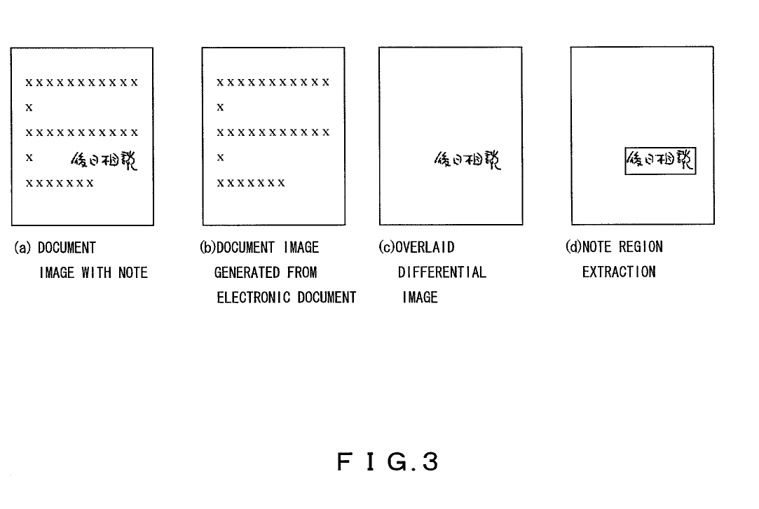

FIG. 3 explains the concept of a note region extraction process.

FIG. 3A shows image data of a document in which a note is taken. This is the image data that is generated by capturing with a scanner, an electronic camera, etc. an electronic document that is printed on paper and distributed, in which the note is taken. FIG. 3B shows document image data generated from the electronic document. A difference between these image data exists in a point that the note is included in the image data shown in FIG. 3A. If the image data of FIGS. 3A and 3B are overlaid, preprints such as characters included in the electronic document, etc. should overlap. This is because the portion other than the note in FIG. 3A is printed from the electronic document. When the images are overlaid, a differential image, from which overlapping characters are removed, is obtained as shown in FIG. 3C. By extracting the remaining image such as characters, etc. in the differential image, the note region is extracted as shown in FIG. 3D.

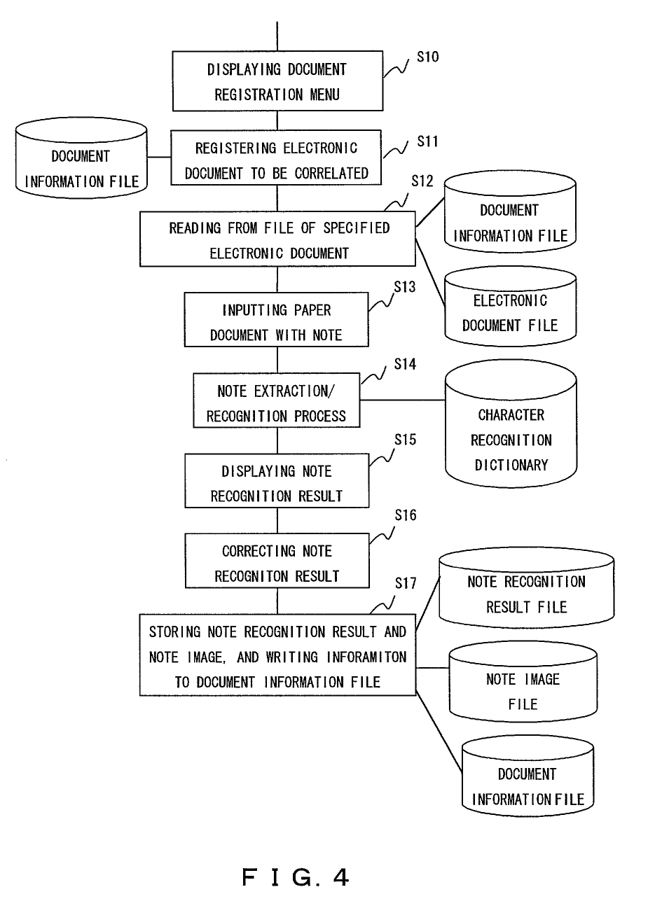

FIG. 4 is a flowchart showing a note information registration/correlation process.

If a user requests a document management registration, a document registration menu is made visible on a display. When the user selects an electronic document registration from the menu via a keyboard, a mouse, etc., locates an electronic document file desired to be registered in a specified directory, and inputs the name of the electronic document file desired to be registered via the keyboard being a user interface, the electronic document registering unit extracts the title, version number, protection information, document type, etc. from the document file, and writes the extracted information to a document information file. Additionally, the user selects a note registration from the document registration menu via the user interface such as a keyboard, a mouse, etc., and inputs or selects from a list the file name of the original electronic document in which a note is taken. Furthermore, the user inputs the paper document in which the note is taken with a scanner, an electronic camera, etc.

The note extracting unit references the document information file, reads the electronic document file registered to the location corresponding to the file name input by the user, and copies the electronic document file in a working area. Furthermore, the note extracting unit extracts only the note portion by making a comparison between the document image with the note, which is input from a scanner, an electronic camera, etc., and the original electronic document file. The note recognizing unit performs character recognition for the extracted note portion. Furthermore, the note registering unit stores a recognition result unchanged in a predetermined location if there is no error, or stores a corrected recognition result in a predetermined location if there is an error. The note registering unit also stores the note image in a predetermined location. The number of notes, a note recognition result, a pointer to a note image, and location information of an image with a note are written to the entry of the corresponding original electronic file in the document information file.

The above described process is explained with reference to the flowchart shown in FIG. 4.

Firstly, instep S10, a document registration menu is displayed for a user. In step S11, an electronic document to be correlated is registered to a document information file. In step S12, the electronic document specified to be correlated is read from an electronic document file by referencing the document information file. In step S13, a paper document with a note, which corresponds to the specified electronic document, is input from a scanner, an electronic camera, etc. Then, in step S14, a note extraction/recognition process is performed. In step S15, a note recognition result is displayed for the user. In step S16, the user corrects the note recognition result if necessary. In step S17, the note recognition result and the note image are respectively stored in a note recognition result file and a note image file, and at the same time, the corresponding information is written to the document information file.

Here, the explanation is provided based on the assumption that the note recognition process properly runs. Actually, however, the recognition process cannot properly run, for example, if a note is not characters. Accordingly, whether or not to perform the note recognition process may be determined by a user specification. In this case, note information correlated to an electronic document is only note image data.

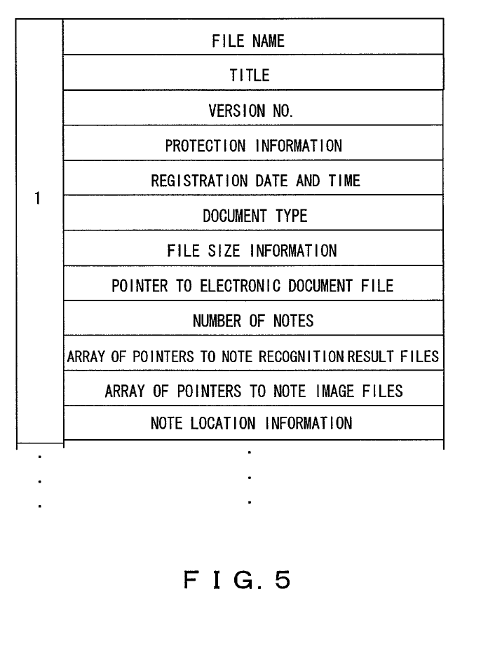

FIG. 5 explains the format of a file stored in a document information file.

If a user issues a request, the document managing unit reads/displays an electronic document, a corresponding note recognition result, and data of a note image by referencing the document information file shown in FIG. 1. The document management file stores the number of notes, an array of pointers to note recognition result files, an array of pointers to note image files, location information of each note in a paper document, etc. in addition to a file name, a document title, file size information such as the number of pages, the number of columns, a data size, etc., protection information (write protection, etc.), a registration date and time, a document type, and a pointer pointing to an electronic document file, which indicates a data location in a memory.

Here, the location information of each note in a paper document indicates in which portion of a document a note exists. For example, when an electronic document is displayed on a screen of a word processor, a line or a column number, which approximately indicates the location in which a note is taken, may be available, or the value (centimeters or inches) of a ruler scale of the word processor may be available for the location of a note if the word processor manages the location of a character on paper in units such as centimeters, inches, etc.

Furthermore, in the preferred embodiment of the present invention, a character recognition process is performed for a note, and a recognition result is stored as character code. Therefore, only an electronic document but also a note recognition result can be used as a search target, when a document search is made.

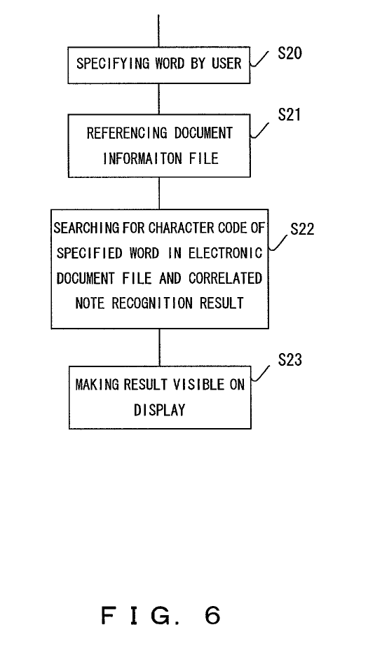

FIG. 6 is a flowchart showing a document search process.

When a user issues a document search request and inputs a word that he or she desires to search via a user interface such as a keyboard, a mouse, etc., the document searching unit references a document information file, searches for the character code corresponding to the requested word in each electronic document data and a note recognition result correlated by the document information file, and makes the result visible on a display.

Namely, if a user specifies a word to be searched in step S20, a document information file is referenced in step S21, and the character code of the specified word is searched in each electronic document file and its correlated note recognition result in step S22. At this time, also the character codes of words within the electronic document are searched. Then, in step S23, the electronic document and the note recognition result, which are found as a result of the search, are displayed.

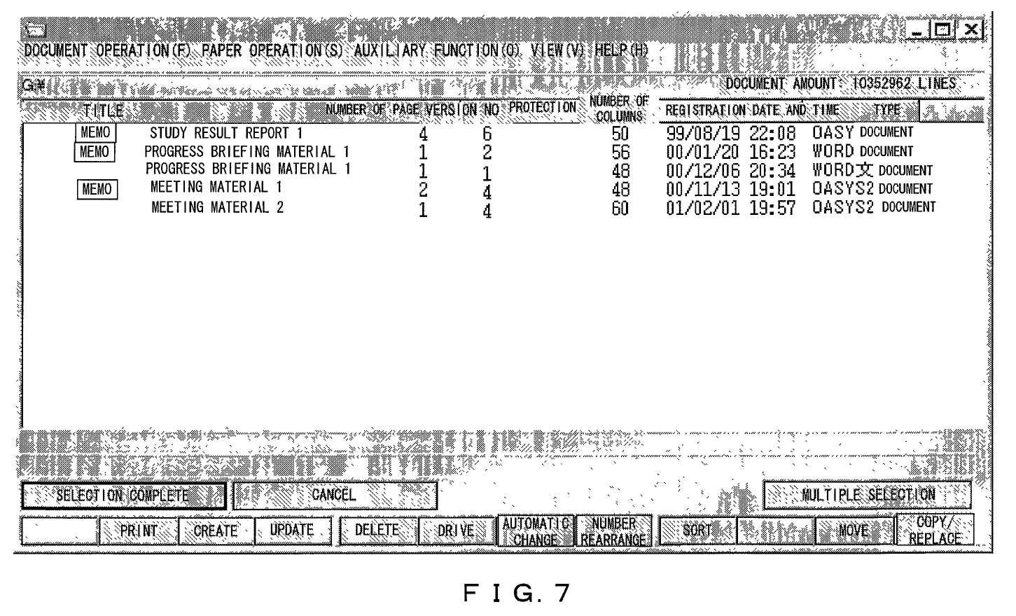

FIG. 7 exemplifies a display of a document list in the case where note data exists. For a document with note data, for example, an indication “note” is attached to the beginning of the document title. In the example shown in FIG. 7, the indication “note” is attached to a study result report 1, so that the presence of note data in addition to the electronic document is notified to a user. Furthermore, it is indicated that note data exists for a meeting material 1 but not for a meeting material 2. The other materials are similar.

As described above, when an electronic document data list is displayed, whether or not note data correlated to an electronic documents exists is indicated.

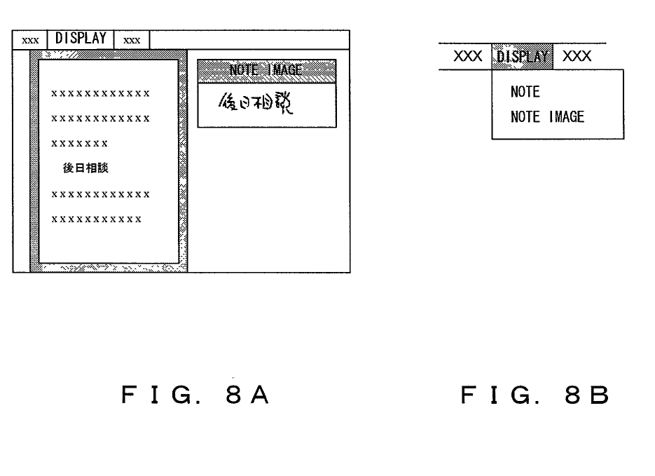

FIGS. 8A and 8B exemplify a display of an original electronic document, a note recognition result, and a note image.

A user selects a menu in a toolbar in a window with a mouse, a keyboard, etc. depending on need, so that a display of a note or a note image is toggled on and off (see FIG. 8B). For example, a note is inserted and displayed in a line corresponding to the location in which the note is taken by changing its color, whereas a note image is displayed in another window. FIG. 8A shows an example where a display of a note and a note image is toggled on.

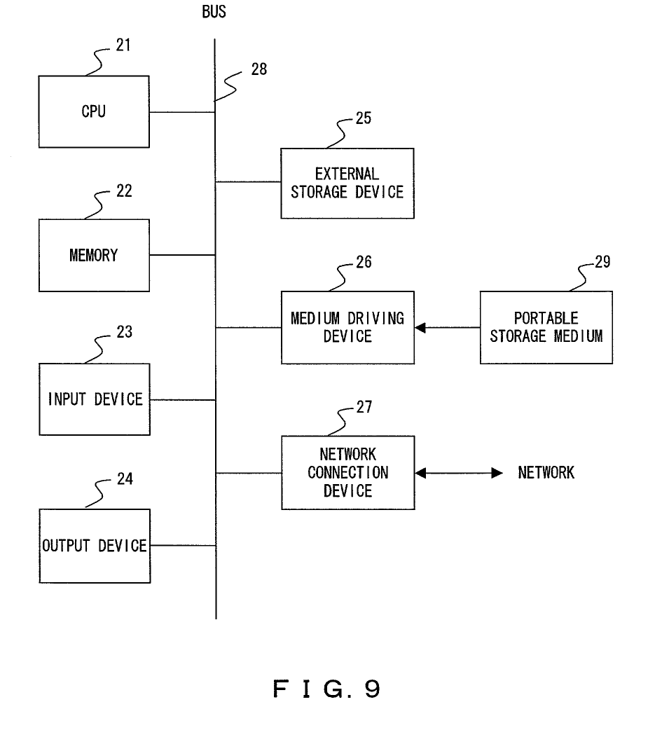

FIG. 9 explains the hardware environment of an information processing device that is required when an apparatus according to the preferred embodiment is implemented by causing the information processing device to execute a program.

A CPU 21 is connected to an external storage device 25 such as a hard disk, or a medium driving device 26 via a bus 28. The medium driving device 26 reads data of a program, etc. from a portable storage medium 29 such as a floppy disk, a CD-ROM, a DVD, etc. The program is read from the external storage device 25 or the portable storage medium 29, copied in a memory 22, and executed by the CPU 21. An input device 23 is configured by a keyboard, a mouse, a display, a scanner, an electronic camera, etc., and used to notify the CPU 21 of a user instruction, or to read a paper document with a note as an image. In the external storage device 25 or onto the portable storage medium 29, a paper document with a note, an original electronic document, etc. are stored. Especially, the document information file 9, the original document file 10, the note recognition result file 11, the note image file 12, the character recognition dictionary 13, etc., which are shown in FIG. 1, are configured.

An output device 24 is configured by a display, etc., and makes a display as shown in FIG. 7 or 8. This device configures a user interface along with the input device 23, such as providing a user with necessary information, or displaying a screen that prompts a user to make an input, etc.

A network connecting device 27 is a device for connecting the information processing device to a network. This device is used to download the program via a network, or to access the above described files via a network if the files are stored in separate locations.

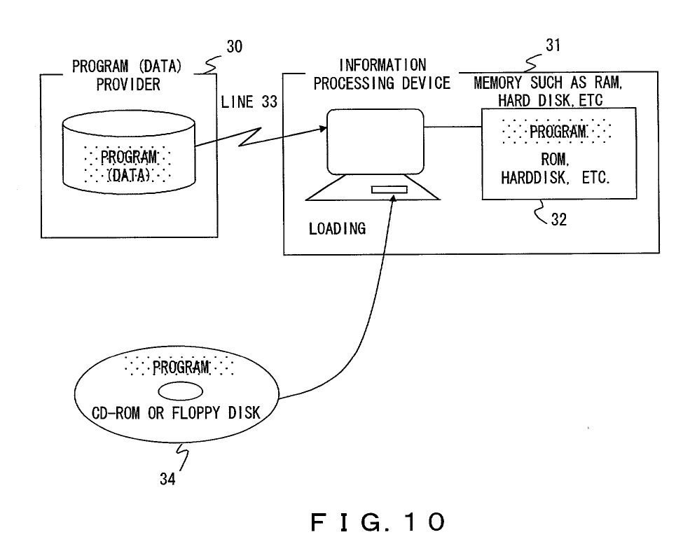

FIG. 10 explains a use pattern of a program (data).

An information processing device 31 can store a program in a memory 32 such as a RAM, a hard disk, etc., and can execute the program. Or, the information processing device 31 may execute the program by loading it from a storage medium 34 such as a CD-ROM, a floppy disk, etc.

Furthermore, the information processing device 31 can access a program (data) provider 30, use a program and data by downloading them, or use the program and data under a network environment.

According to the present invention, also a note taken in a paper document printed from an electronic document can be managed as electronic data, whereby information can be electronically managed in a unified manner without storing a paper medium in which a note is taken.

What is claimed is:

1. A program for causing an information processing device to execute a document managing method electronically managing a note taken in a paper document printed from an electronic document, the method comprising:
reading as an image a document in which a note is taken;
extracting information about the note from the read image; and
correlating and electronically storing the electronic document and the information about the note.

2. The program according to claim 1, wherein the information about the note includes image data of the note.

3. The program according to claim 2, the method further comprising recognizing a character written in the image data of the note.

4. The program according to claim 3, wherein the electronic document, a note image, and a recognition result of the note image are correlated and electronically stored in the correlating and storing step.

5. The program according to claim 3 or 4, the method further comprising
searching contents of the electronic document and the recognition result in accordance with a search keyword input from a user, and displaying a search result.

6. The program according to claim 2, wherein
the image data of the note is obtained by taking a difference between an image generated from the electronic document and the read image.

7. The program according to claim 1, wherein
the information about the note includes location information indicating a location of the note within a printed document.

8. A document managing apparatus electronically managing a note taken in a paper document printed from an electronic document, comprising:
a unit reading as an image a document with a note;
a unit extracting information about the note from the read image; and
a unit correlating and electronically storing the electronic document and the information about the note.

9. The document managing apparatus according to claim 8, wherein
the information about the note includes image data of the note.

10. The document managing apparatus according to claim 9, further comprising
a unit recognizing a character written in the image data of the note.

11. The document managing apparatus according to claim 10, wherein
said correlating and storing unit correlates and electronically stores the electronic document, a note image, and a recognition result of the note image.

12. The document managing apparatus according to claim 10 or 11, further comprising
a unit searching contents of the electronic document and the recognition result in accordance with a search character input from a user, and displaying a search result.

13. The document managing apparatus according to claim 9, wherein
the image data of the note is obtained by taking a difference between an image generated from the electronic document and the read image.

14. The document managing apparatus according to claim 8, wherein
the information about the note includes location information indicating a location of the note within a printed document.

15. A document managing method electronically managing a note taken in a paper document printed from an electronic document, comprising:
reading as an image a document with a note;
extracting information about the note from the read image; and
correlating and electronically storing the electronic document and the information about the note.

16. The document managing method according to claim 15, wherein
the information about the note includes image data of the note.

17. The document managing method according to claim 16, further comprising
recognizing a character written in the image data of the note.

18. The document managing method according to claim 17, wherein
the electronic document, a note image, and a recognition result of the note image are correlated and electronically stored in the correlating and storing step.

19. The document managing method according to claim 18 or 19, further comprising
searching contents of the electronic document and the recognition result in accordance with a search keyword input from a user, and displaying a search result.

20. The document managing method according to claim 16, wherein
the image data of the note is obtained by taking a difference between an image generated from the electronic document and the read image.

21. The document managing method according to claim 15, wherein
the information about the note includes location information indicating a location of the note within a printed document.

22. A storage medium readable by an information processing device, on which is recorded a program for causing the information processing device to execute a document managing method electronically managing a note written in a paper document printed from an electronic document, the method comprising:
reading as an image a document with a note;
extracting information about the note from the read image; and
correlating and electronically storing the electronic document and the information about the note.
